(19) United States
(12) Patent Application Publication
(10) Pub. No.: US 2010/0147388 A1
(43) Pub. Date: Jun. 17, 2010

(54) DIRECTIONAL GATE VALVE

(76) Inventor: Paulo Cezar Silva Paulo, Katy, TX (US)

Correspondence Address: Zarian Midgley & Johnson PLLC, University Plaza, 960 Broadway Ave., Suite 250, Boise, ID, 83706, US

(21) Appl. No.: 12/634,964

(22) Filed: Dec. 10, 2009

Related U.S. Application Data
(60) Provisional application No. 61/122,001, filed on Dec. 12, 2008.

(51) Int. Cl. F15D 1/00; F16K 3/00

(52) U.S. Cl. 137/1; 251/326

(57) ABSTRACT

A directional gate valve is disclosed. The gate valve comprises a valve body. A first flow path, a second flow path and a third flow path are positioned in the valve body. The second and third flow paths are capable of fluidly communicating with the first flow path through a connecting flow configuration. A gate is positioned within the gate valve at a location separate from the connecting flow configuration. The gate is configured to move back and forth between a first position and a second position in the valve body. When the gate is in the first position the gate provides fluid communication through the second flow path and simultaneously blocks fluid communication through the third flow path. When the gate is in the second position the gate provides fluid communication through the third flow path and simultaneously blocks fluid communication through the second flow path.

### RELATED APPLICATION

This application claims priority to U.S. Provisional Patent Application 61/122,001, filed Dec. 12, 2008, and entitled SUBSEA BOOSTING CAP SYSTEM, the disclosure of which is hereby incorporated by reference in its entirety.

### BACKGROUND

1. Field of the Disclosure

The present disclosure relates generally to gate valves, and in particular, to directional gate valves.

2. Description of the Related Art

Gate valves are generally well known in the art and have many uses. For example, in oilfield completions, the most common type of valve in use is the gate valve, due to its simple construction and effective design. This valve type is typically mounted with three main sealing components with a full bore passage feature, and can have a compliant relative movement between the parts. This can result in an increase in seal effectiveness that is directly proportional to the rising pressure, which can provide for relatively robust and reliable performance.

A gate valve construction can be based on a blocking system using, for example, a flat rectangular plate or a cylinder. Through a linear movement, a portion of the blocking system can be positioned across a bore passage to close the gate valve; or the blocking system can be positioned so as not to cover the bore passage to open the gate valve.

However, conventional gate valves generally are only designed to either permit flow or to block flow altogether. Multiple valves and tee junctions are used to change the direction of the flow path.

The present disclosure is directed to overcoming, or at least reducing the effects of, one or more of the issues set forth above.

### SUMMARY

An embodiment of the present disclosure is directed to a directional gate valve. The gate valve comprises a valve body. A first flow path, a second flow path and a third flow path are positioned in the valve body. The second and third flow paths are capable of fluidly communicating with the first flow path through a connecting flow configuration. A gate is positioned within the gate valve at a location separate from the connecting flow configuration. The gate is configured to move back and forth between a first position and a second position in the valve body. When the gate is in the first position, the gate provides fluid communication through the second flow path and simultaneously blocks fluid communication through the third flow path. When the gate is in the second position, the gate provides fluid communication through the third flow path and simultaneously blocks fluid communication through the second flow path.

### BRIEF DESCRIPTION OF THE DRAWINGS

FIGS. 1A and 1B illustrate a directional gate valve for directing fluid, according to an embodiment of the present disclosure.

FIG. 2 illustrates a directional gate valve for directing fluid, according to another embodiment of the present disclosure.

FIG. 3 illustrates a directional gate valve for directing fluid, according to yet another embodiment of the present disclosure.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

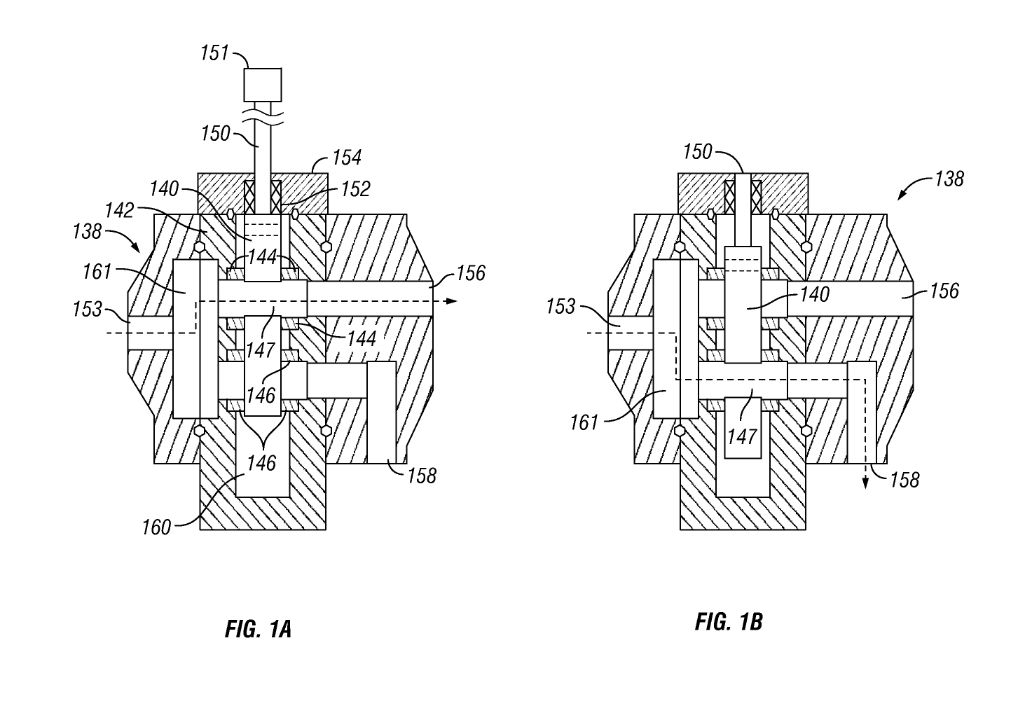

FIGS. 1A and 1B illustrate a directional valve 138, according to an embodiment of the present disclosure. Directional valve 138 comprises a gate 140 set in a valve body 142 comprising upper valve seats 144 and lower valve seats 146. The gate 140 is the on/off element of the system and can seal against the seats 144 and 146. Gate 140 can be any suitable gate, such as a slab gate, a cylindrically shaped gate or any other suitable gate that can function to direct the flow of water through the desired flow path. In an embodiment, the gate 140 can be a slab with flat sides and having a rectangular or square cross-section. A bore 147 can be positioned in the gate 140 to allow fluid flow therethrough. The gate 140 can traverse back and forth in gate chamber 160 so as to position bore 147 to provide the ability to select a desired flow direction.

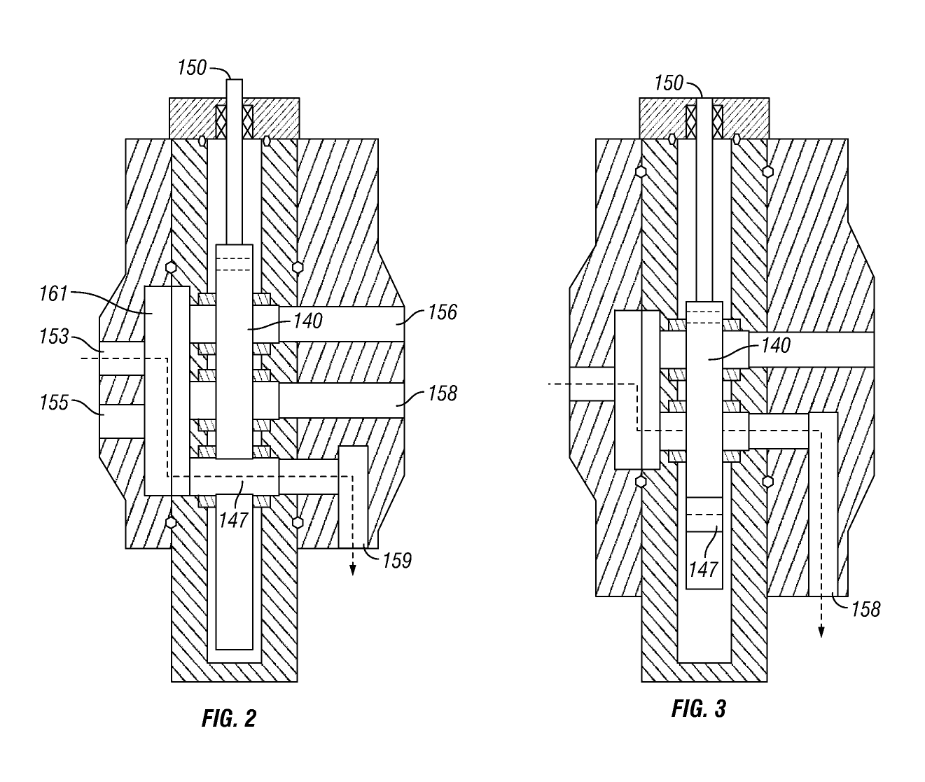

The valve body 142 can be the main structural member of the system. In an embodiment, valve body 142 can integrate all components to provide structural capacity, flow path integrity, and pressure containing capability. In an embodiment, valve body 142 has a dual bore passage configuration which provides the ability to divert the flow according to the position of gate 140. In other embodiments, valve body 142 can have three or more passages, as illustrated, for example, in FIG. 2.

The upper valve seats 144 and the lower valve seats 146 physically engage the gate 140 and the valve body 142 so as to provide sealing capability on both sides of gate 140 around both flow paths 156 and 158. In this design concept, the valve seats 144 and 146 can provide isolation between the dual flow paths 156 and 158.

A bonnet assembly 154 can enclose a stem 150 and stem seal packing 152. The stem 150 can be the physical link between an actuator 151 and the gate 140. Actuator 151 can be any suitable actuation system. Such actuations systems are well known in the art. The stem 150 can act as a dynamic barrier of the system, connecting the gate 140 to the actuator 151 to provide the valve functional motion. While the bonnet assembly 154 is illustrated with a single stem 150, any suitable number and type of actuators can be employed, such as hydraulic, manual, electrical and ROV operated actuators. Bonnet 154 can provide structural retention for the dynamic sealing around the stem actuator 150, as well as structural strength to mount an actuation system of any type.

In an embodiment, directional valve 138 can comprise a single gate 140 activated by a single actuator. In other embodiments, multiple gates and/or multiple actuators can be employed. The gate 140 can either be made as one integral piece or as an assembly of multiple parts, as desired. A sealing system (not shown) between gate 140 and valve seats 144 and 146, as well as between the valve seats and valve body 142, can include any suitable type of sealing mechanism. For example, the sealing mechanism can comprise a metal to metal type seal, or any other suitable type of seal made of any suitable material.

Directional valve 138 can include a single inlet, illustrated as flow path 153, and two outlets, flow paths 156 and 158, as illustrated in the embodiment of FIGS. 1A and 1B. Flow paths 156 and 158 can fluidly communicate with the flow path 153 through a connecting flow configuration 161. The connecting flow configuration 161 is positioned within gate valve 138 at a location separate from gate 140.

FIG. 1A illustrates directional valve 138 in a first position for allowing fluid to flow through a flowpath 156 and simultaneously blocking fluid flow through a flow path 158. FIG. 1B illustrates directional valve 138 in a second position, which allows fluid to flow through flow path 158, as shown in the embodiment of FIG. 1, while simultaneously blocking fluid flow through the flowpath 156. During operation, the stem 150, which can be connected to an actuator (not shown), can force gate 140 from the first position, shown in FIG. 1A, to the second position shown in FIG. 1B, thereby simultaneously beginning fluid flow through flow path 158 and stopping fluid flow through the flow path 156.

FIG. 2 illustrates another embodiment of the present application that is similar to the embodiments of FIGS. 1A and 1B, except that the embodiment of FIG. 2 includes an additional flowpaths 155 and 159. In this embodiment, gate 140 simultaneously blocks fluid flow through any two of the three outlet flow paths (e.g., flow paths 156 and 158, as shown in FIG. 2) while providing for flow through the third outlet flow path (e.g., flow path 159, as shown in FIG. 2). Additional inlet flowpath 155 is shown to illustrate the possibility of multiple inlets. In yet other embodiments, additional flowpaths can be included. For example, four or more outlet flow paths and/or three or more inlet flow paths can be employed to provide any desired number of potential flow paths through which fluid can be directed, or from which fluid can be directed, using a single valve.

FIG. 3 illustrates another embodiment of the present disclosure that is similar to the embodiment of FIGS. 1A and 1B, except that the gate 140 and gate chamber 160 are designed to allow for the gate 140 to be positioned at a third position in the valve body 142. When at the third position, the gate 140 can block fluid communication through the flow paths 156 and 158, thereby stopping fluid flow through the valve 138.

While the directional gate valves of the present disclosure have been discussed as having a single inlet and multiple outlets, in yet other embodiments, the gate valves of any of the above described embodiments can be arranged so that there are a plurality of inlets and a single outlet; or alternatively a plurality of inlets and a plurality of outlets. For example, the flow arrangement can be reversed so that outlets 156 and 158 of FIGS. 1A and 1B can instead be inlets and the inlet 153 can be the outlet.

The directional gate valves of the present disclosure can potentially be used in any application in which gate valves are typically employed. For example, the gate valves 138 can be employed in an offshore fluid production system, such as in the offshore subsea boosting cap system described in U.S. patent application Ser. No. ______[AKER.019U]______, the disclosure of which is hereby incorporated by reference in its entirety. Other possible applications include, for example, well completion assemblies, chemical production facilities and pipelines used for transporting fluids from one destination to another.

Although various embodiments have been shown and described, the disclosure is not so limited and will be understood to include all such modifications and variations as would be apparent to one skilled in the art.

What is claimed is:

1. A directional gate valve, comprising:
a valve body;
a first flow path positioned in the valve body;
a second flow path and a third flow path in the valve body, the second and third flow paths being capable of fluidly communicating with the first flow path through a connecting flow configuration; and
a gate positioned within the gate valve at a location separate from the connecting flow configuration, the gate being configured to move back and forth between a first position and a second position in the valve body,
wherein when the gate is in the first position the gate provides fluid communication through the second flow path and simultaneously blocks fluid communication through the third flow path, and further when the gate is in the second position the gate provides fluid communication through the third flow path and simultaneously blocks fluid communication through the second flow path.

2. The directional gate valve of claim 1, further comprising a fourth flow path in the valve body, the fourth flow path fluidly communicating with the first flow path through the connecting flow configuration; wherein when the gate is positioned at a third position in the valve body, the gate provides fluid communication through the fourth flow path and simultaneously blocks fluid communication through the second and third flow paths.

3. The directional gate valve of claim 1, further comprising a fifth flow path positioned in the valve body, the fifth flow path being capable of fluidly communicating with the second and third flow paths through a connecting flow configuration

4. The directional gate valve of claim 1, wherein the gate is capable of being positioned at a third position in the valve body, so that when the gate is at the third position, fluid communication through the second and third flow paths is blocked, thereby stopping fluid flow through the valve.

5. The directional gate valve of claim 1, wherein the first flow path is an inlet and the second and third flow paths are outlets.

6. The directional gate valve of claim 1, wherein the first flow path is an outlet and the second and third flow paths are inlets.

7. The gate valve of claim 1, further comprising an actuator physically coupled to the gate for moving the gate from the first position to the second position.

8. The gate valve of claim 7, wherein the actuator is physically coupled to the gate via a stem.

9. The gate valve of claim 7, wherein the actuator is a hydraulically operated actuator.

10. The gate valve of claim 7, wherein the actuator is a manually operated actuator.

11. The gate valve of claim 7, wherein the actuator is an electrically operated actuator.

12. The gate valve of claim 7, wherein the actuator is an ROV operated actuator.

13. The gate valve of claim 1, further comprising one or more valve seats positioned proximate the gate in the first outlet flow path.

14. The gate valve of claim 13, further comprising one or more valve seats positioned proximate the gate in the second outlet flow path.

15. The gate valve of claim 1, wherein the gate valve only has a single gate.

16. The gate valve of claim 15, wherein the gate can be moved between the first position and the second position using only a single actuator.

17. A method of directing flow using the directional gate valve of claim 1, the method comprising actuating the gate to both a) simultaneously start fluid flow through the first outlet flow path and b) stop fluid flow through the second outlet flow path.
